(19) United States
(12) Patent Application Publication
(10) Pub. No.: US 2008/0262945 A1
(43) Pub. Date: Oct. 23, 2008

(54) Ontological subscription and publication system with automatic notification of matching advertisements, products, and services within the ontological system for buyers and sellers

(76) Inventor: Daniel Carver Clark, Bowie, MD (US)

Correspondence Address: Daniel Carver Clark, 12412 Gladys Retreat Circle, Bowie, MD, 20720, US

(21) Appl. No.: 12/078,333

(22) Filed: Mar. 28, 2008

Related U.S. Application Data
(60) Provisional application No. 60/907,297, filed on Mar. 28, 2007.

(51) Int. Cl. G06Q 30/00; G06F 7/06; G06F 17/30

(52) U.S. Cl. 705/27; 707/5; 707/E17.014

(57) ABSTRACT

The present invention relates to an ontological subscription and notification system of advertisements from sellers to buyers. An ontology is defined within a controller (e.g.: a database, a computer program running on a server, etc) and sellers of products can submit/publish data representing a product(s) or service(s) via the internet to the controller that the controller then matches to its ontology hierarchy and stores in a computer database or other storage mechanism. A buyer of product(s) or service(s) can submit subscription data representing a product(s) or service(s), ontological category level, desired price range (and other ontological subscription criteria such as expiration date for notifications of matching products and services from sellers, product properties, quantity, seller distance from buyer, etc) via the internet to the controller that the controller then matches to its ontology hierarchy, stores in a computer database or other storage mechanism. The controller periodically (or continually) queries the database to determine if any of the buyers subscription data matches a sellers published product(s) or service(s) or falls within the ontological child-category of a parent-category or within any range within the ontology specified by the buyer. Potential buyers then have the option to be notified of the matching sellers published product(s) or service(s) via email, instant message, SMS, telephone, etc. The method and apparatus of the present invention have applications on the Internet as well as conventional communications systems such as voice telephony.

### BACKGROUND OF THE INVENTION

1. Field of the Invention

The method and apparatus of the present invention relates to automatic notifications of products or services matched to a buyers subscriptions in an ontology, from a sellers published products or services within an ontology, using electronic networks.

2. Background

There are dozens of different buyer-seller protocols in use today. However, almost all of those systems are seller-driven in the sense that they focus on the methods and processes available to the seller, allowing him to price, package or configure goods and services more effectively. Stores, catalogs, classified advertisements, telemarketing, auction houses, even on-line computerized reservation systems such as SABRE, are all seller-driven. Traditionally, it is the seller's job to attract buyers and then to complete the sale. Thus, in a seller-driven system, the advertising cost of the transaction and the attendant risks that such advertising will be unsuccessful falls upon the seller.

Most goods and services sold at retail are done so using a general seller-driven protocol whereby the seller sets a price and the buyer decides whether or not to accept that price. Prices for some services, such as airline tickets, might change frequently, but the buyer must still wait for the seller to offer a price he finds acceptable. Obviously, some forms of commerce offer far more give and take with offers and counteroffers being exchanged, however the vast majority of retail purchases utilize seller-driven, fixed-price, non-negotiable pricing protocols.

Auctions are probably the most frequently used system whereby prices are not fixed by the seller. Here too, the system is seller-driven. The buyer does not find the seller, rather the seller attracts numerous buyers who, as a group, determine the final selling price—which the seller may subsequently reject unless the item auctioned is being sold without a reserve.

Even on-line reservation systems are seller-driven. Airline reservation systems such as SABRE are in the business of constantly posting airfares. Travel agents and consumers are on the bid side of the process. However, since they cannot communicate their bids to the airlines, they must wait until an “asked” fare is quoted which meets their needs.

Other commerce systems are exchange-driven. These systems, such as NASDAQ or the New York Stock Exchange (NYSE) match buyers and sellers by offering an efficient, fair and orderly marketplace. They favor neither buyers nor sellers, but simply effectuate communications that allow for the matching process to take place. An example of an automated exchange-driven commerce system for trading futures is disclosed in U.S. Pat. No. 4,903,201.

A buyer-driven system is one in which buyers find sellers, such as a “wanted to buy” classified ad. A help wanted ad is a buyer-driven inquiry since the employer is looking to locate and buy the services of a qualified employee. The inquiry is advertised to a large number of potential “sellers,” a number of which may respond by submitting their resumes to the prospective employer.

Buyer-driven systems yield certain benefits and efficiencies that other commerce systems do not. Buyers using such a system can exercise more control over the terms and conditions of their purchases. Additionally, when a large number of potential sellers exist, but those sellers do not have the resources to advertise globally, it makes sense for buyers, if they can, to take the initiative in communicating its needs to the sellers.

Currently, there exist certain unilateral buyer-driven systems of commerce. A good example of such a system is the typical reward system wherein a “buyer” broadcasts/publishes an offer for a reward to anyone who completes a particular task. That type of system is unilateral because the offer can only be accepted by performance of the designated task. Thus, unilateral systems can be utilized only for limited types of transactions which allow for acceptance by performance.

Bilateral buyer-driven systems seek to consummate contracts between buyers and sellers based on mutual promises to perform. Bilateral buyer-driven systems, however, currently represent an extremely small portion of overall commerce due to a variety of factors. First, and perhaps foremost, buyers generally either cannot or do not want to invest the time, money or other resources required to locate an indefinite number of potential sellers and communicate the buyer's purchasing needs to each of the potential sellers. This is especially true of the individual consumer who often cannot afford to pay substantial transaction costs.

For example, an individual seeking car repair services generally would not want to contact every single repair shop and communicate details of his repair needs to each. The benefits to the consumer from doing so (e.g., achieving a lower price) would be vastly outweighed by the amount of time and money expended in the effort.

Also, buyer-driven systems are not prevalent because buyers do not want to be inundated with numerous offers from potential sellers, many of whom may be marginal or unqualified (e.g. a thousand real estate brokers or car dealers all calling one buyer). Buyer-driven systems impose inherent costs on sellers as well. If each buyer has a different set of purchasing specifications and communicates his needs using non-uniform language, sellers must pay a substantial cost even to review and understand each individual request. Moreover, sellers are often not amenable to customizing their products for individual buyers.

As a rule, the greater the number and complexity of the buyer's purchase conditions, the more difficult it is to have a buyer-driven market, since advertising costs generally rise with the number of conditions that must be communicated, and the potential number of sellers who can understand and fulfill increasingly complex conditions usually declines. Buyer-driven markets function best when there is a well-defined purchase need, when a “brand” provides quality assurance to the buyer such as the name of a major airline carrier or when the item is a commodity such as oil or coal.

An example of a regularly used bilateral buyer-driven process is the system utilized by large organizations such as companies or governments which want to purchase significant amounts of goods or services at the lowest possible price. To begin, they formulate a detailed written specification setting forth the quantities and requirements of what they are looking to buy. This document is typically called a “Request for Proposal” (RFP). Once finalized, RFPs are then distributed to a list of known potential suppliers. If the value of the RFP is high enough, as it is might be with a large government contract, the buyer may bear the added expense of trying to attract the widest number of sellers by paying to publish the RFP in newspapers and trade magazines.

Potential suppliers which identify an RFP that they might be able to fulfill, will first evaluate it to decide whether or not to invest the necessary time and effort to submit a formal proposal. Typically, some number of suppliers submit binding proposals to the buyer by a deadline established in the RFP. Once submitted, proposals are then evaluated by the buyer. One proposal is usually selected and the corresponding supplier notified that it has “won” the business at the price quoted.

Large organizations can take advantage of the benefits afforded by the RFP process because their volume buying represents a worthwhile opportunity for suppliers to compete for their business. They also have the resources to communicate their buying needs to a sufficient number of suppliers. As a result, they can often achieve substantial unit cost savings, especially on commodities or commodity services (such as paper clips or long distance service) and on perishable items (such as airline tickets and hotel rooms).

Individual consumers cannot effectively participate in such bilateral buyer-driven systems because they generally do not have the buying power and resources of large organizations. Some consumers have found ways to group together in order to achieve some measure of the volume buying power enjoyed by large organizations. Many consumers, however, are deterred from joining buying groups because of the groups' various requirements and limitations.

As commerce seeks to utilize the inherent advantages of the Internet, many types of commerce systems, such as malls, catalogs and auction house, are being implemented on the Internet. These approaches generally seek to create better seller or exchange-driven systems whereby the sale of goods and services is made more efficient.

While there have been some attempts to use the Internet to effectuate bilateral buyer-driven transactions, those attempts have been largely unsuccessful. Currently, there are “bulletin board” type sites on the Internet where buyers can post “wanted” advertising at little or no cost. Thus, any consumer could post his own RFP looking for companies willing to sell him the exact airline tickets they are looking to buy or a particular car with specified options included. Because Internet postings are global, the buyer theoretically has the ability to communicate his RFP to a large number of potential sellers. In practice, however, this process is ineffective as a buyer-driven system of commerce because potential sellers generally do not frequent the various “bulletin board” sites or respond to the individual RFPs.

Sellers are deterred from using such a process because there is no guarantee of the authenticity of the RFP, the cost of negotiating with individual consumers is often too high. Additionally, “bulletin boards” containing RFPs are scattered across the Internet making it difficult, if not impossible, for sellers to find relevant RFPs. Finally, when analyzing the RFPs that are posted on the Internet, sellers are confronted by an almost overwhelming number of different formats, conditions, terms, and language styles in the RFPs. Sellers must spend a large amount of time and money even simply to understand the prospective buyer's needs and the legal ramifications of the particular language used in each RFP. In sum, buyer RFPs posted on the Internet represent too much uncertainty for sellers. Sellers are not willing to spend the time and money finding and pursuing Internet RFPs. In turn, the absence of a critical mass of sellers reduces the incentive for buyers to post their RFPs.

Accordingly, there is a need for a centralized buyer-driven system of bilateral electronic commerce capable of being utilized by even small consumers to communicate their purchasing needs globally to potential sellers which addresses the deficiencies of the prior art. The advantages of such a system are manifold. It is the only way for a buyer efficiently to reach a large market of potential sellers. It also allows the buyer to set the terms he is willing to accept. As an additional advantage, it gives the sellers an indication of the state of the market for their product. Finally, since this technology is electronically based, costs are kept to a minimum.

A key element necessary to achieve a critical mass of buyer and seller participation in such a electronic buyer-driven system is the buyer and seller's ability to define products or services within a way that allows a buyer to generalize semantically about the product or service he or she wants. For example, many times prospective buyers may only want to buy say any “red convertible”. All of the current systems (ie: Google Base, eBay.com, Craigslist.org, Cars.com, etc) only allow a buyer to search for an exact convertible with a defined make and model.

Additionally, buyers are forced to search day after day for the same product or service they want. A buyer wishing to buy a red 2005 Ford Mustang on a website (e.g.: http://www.Cars.com, http://base.google.com, etc) must visit the website everyday and enter his search criteria. If the buyer does not search for the product he wants during the time period that a seller sells the product or service the buyer wants, both the buyer and seller lose out completely.

There is a need for a system to allow a buyer to be unspecific or specific in what he or she wants.

There is a need for a system to allow a buyer to be notified when his or hers unspecific or specific criteria for a product or service is matched within a system.

The present invention would pre-define multi-level categories or ontologies that have parent categories such as “automobile” which contain child categories for the ‘Make’ such as: “Toyota”, “Ford”, “Lexus”, “Mercedes”, etc. The “Ford” category would contain child categories for each make's model such as “Mustang”, “F-150”, “Bronco”, “Taurus”, etc. The “Mustang” would have a child category which contained attributes of the model, such as: “convertible”, “automatic transmission”, etc.

When a seller wants to sell a “Ford Mustang” convertible, they would select the appropriate fields on the systems website that would populate fields on the web browsers interface pulled from the ontology. The buyer would use the web interface to the system to define his subscription criteria as well. For instance, the buyer could select just “convertible” on the subscription webpage for the system to be notified of any cars offered for sell by sellers that are convertibles. The buyer could optionally specify “Ford”, “Lexus” and “convertible” to be notified of any cars for sell that are either a “Ford” or “Lexus” with the attribute of “convertible”. This type of flexibility offered in the current invention would allow a buyer to be extremely unspecific if the buyer wished to be so, as many buyers may only want to be notified of SUV's for sale at a certain price or cars given the attribute “luxury” or the buyer may be more specific if they know exactly what they want.

It is another object of the present invention to allow for purchase offers where more than one seller may bind the buyer to the purchase offer.

Another object of the present invention is to show how all or part of the system can be practiced using non-electronic means such as printed media or advertisements in newspapers.

These and other objects of the invention will be apparent to those skilled in the art from the following detailed description of the invention, the accompanying drawings and the appended claims.

### SUMMARY OF THE INVENTION

In a preferred embodiment, the present invention provides a method and apparatus for a real-time ontological subscription system that notifies buyers and sellers of advertisements. The present invention provides automatic notifications of products or services matched to a buyers subscriptions in an ontology, from a sellers published products or services within an ontology.

Very often, when we want to buy a product, we have a certain price in mind, a time period in which the transaction should take place, and the type of thing we want to buy. For example, people generally know the type of thing that they would like to buy, and the price range, but are forced to pick a specific type of the thing when they go to search for the product, because of the price of the product at the moment they inquire about it (or from research or word of mouth referrals).
What if the buyer of such products wanted to make the time window for finding products irrelevant or arbitrary? Current systems have a “present-only” time window when buyers go to say BestBuy.com to find a widget.
What if the buyer of such products on the internet wanted to generalize about the product they wanted and were manufacturer agnostic? Could a buyer of products on the internet use any current system, to express examples, such as the following:
   1. “Let me know when you have any type of desktop computer hard-drive priced below $X dollars ?”
   2. “Let me know when a computer monitor is for sale that is also touch screen capable”
   3. “Let me know when a red Toyota SUV made before the year 2003, within a 10 mile radius of my zip code, is priced below $13,000”
   4. “Inform me when a Nintedo Wii console is for sale in addition to two WiiChuks”.
Currently, the answer is no.

In addition to the afore mentioned problems, buyers of products and services on the internet currently have only two options when they want to buy a product that is not available or within their price range:
Check back frequently to the website in question, and hope that the product price or availability has changed
Set a price alert for one specific item (only a very small number of websites have this option currently)

Internet consumers miss many opportunities to buy a product, since they check back when sales are over, and the products are no longer offered. The sellers of these products also lose out, by not reaching the pool of buyers who want to buy their products. Price alerts are ineffective, because the majority of the time, the user doesn't want a specific item, but may want a specific class, category of product or a specific product category with caveats at a certain price.

The system in the present invention will act as a central repository for ontologically categorizing advertisements from publishers and notifying subscribers.

Publishers of advertisements will go to a website and enter in a description of the product they are selling. Once the publisher enters in feature information (e.g.: manufacturer, height, color, etc, expiration date), the system will then convert this into data that is stored on a server. Publishers can optionally do bulk uploads via the website or via an API, that is to be developed later.

Subscribers will go to the website and enter in a description of the product they want to buy. They will also enter in the medium of choice that they wish to be notified with (e.g.: SMS, email, instant messenger, etc.). The system will then convert this into data that can be used to query all published deals. If any matching published advertisements are found, the subscriber(s) would be notified via their medium of choice. If nothing is found at the time the buyer enters his subscription information, the system would periodically poll its databases to see if any subscriptions matched any published products, and notify any subscribers if necessary.

Another example would be: An auto dealership (the seller) wants to inform potential auto consumers (the buyers) of its automobiles (product) that it has in its inventory that it is currently offering with a deep discount (the price). Currently, the only options sellers have at their disposal are: ads on websites like cars.com, craigslist.org; ads in newspapers and circulars, pop-up ads, ads on television.

The potential pool of buyers either have to get lucky and see the advertisements when they are aired or repeatedly go to the websites where the cars are advertised for sale, to see if the car they want is within their price range. What's worse is, the buyers could check back on a website to see if any of the automobiles they are interested in are available randomly over a given time period and could easily miss a day or week or more when the very product they are interested in is for sale in the buyers target price range. The system in the present invention would internally represent the automobile ontological relationships within its databases, allowing the buyer and seller to express a multitude of buying and selling decisions and expressions that would eliminate this problem all together.

For example, a buyer could now express with a subscription saved to the system, that he wants to be notified when a Toyota SUV is put on sale for $15,000 or below, that weighs less than 6000 pounds within the next 8 weeks. A seller of an automobile could come along and then publish that he is selling a 4Runner for $13,000. Though the seller never mentioned that he was selling a Toyota or an SUV, the ontological system can infer this from the ontological relationships inherent within the system.

As the ontology concepts are given more information (such as height, length, gas mileage, passenger seating, horsepower, etc), the buyer and seller can leverage all of this information to create very rich notification subscriptions and published feeds to be notified of from the ontological system.

The present system can be used for real estate notifications, airfare, software, and many more products and services.

### DETAILED DESCRIPTION OF THE INVENTION

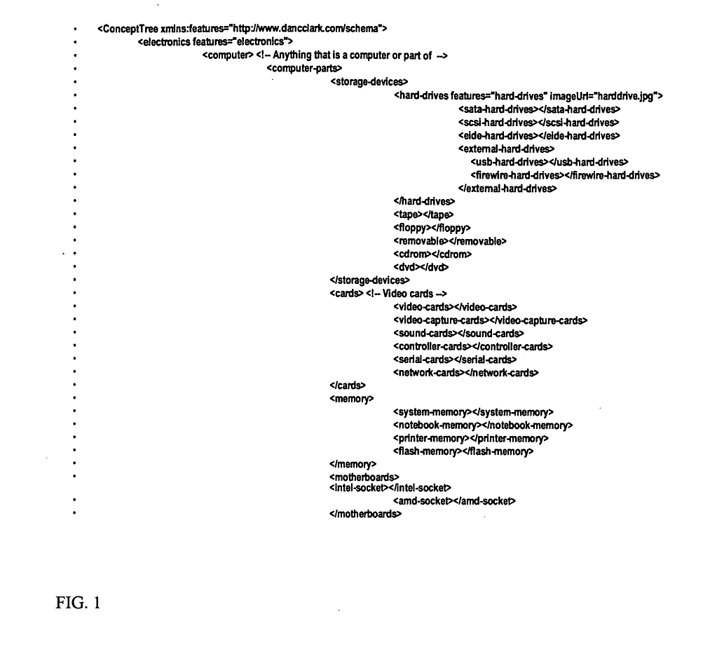

The method and apparatus of the present invention relates to automatic notifications of products or services matched to a buyers subscriptions in an ontology, from a sellers published products or services within an ontology, using electronic networks. By predefining basic concepts from a subset of products and services into an ontology (hierarchical structuring of knowledge) as seen in FIG. 1, a seller of a product or service can publish ontological info (enter a description of the product or service that the system converts to ontological concept data) that is stored in the ontological database, which creates a subscription “feed” that a potential buyer of the product or service can subscribe to. The seller enters in a description of the product or service (in addition to price and optional information like location, quantity, attributes) into the system which then transforms the seller's description into ontological data that matches up with the systems stored ontology structures (see FIG. 1) and saves it to a database or the file system.

The system can expose the ontology via a web interface that allows the buyer or seller to select different categories or sub-types or objects via a number of user interface controls (e.g.: list controls, drop down controls, etc). The word “objects” or “object” used in the previous sense refers to a type in the ontology that has zero or no sub-types. For instance, in an automobile ontology, the type “Honda” would have a sub-type or object called “Civic”. Because a Civic is a particular model of a Honda, it cannot have a sub-type, so we could refer to it as an object.

The buyer of the product or service can at anytime enter in a description of the product or service (in addition to price and optional information like location, quantity, attributes) into the system which then transforms the description into ontological query data that matches up with the systems stored ontology concepts (see FIG. 1). The ontological system would store the buyer's ontological query data within its database. The system would then periodically scan all the ontological data entered by sellers to see if it matched what any of the buyers have entered. Whenever a buyer entered in a new subscription feed, the system would check that against existing seller subscriptions and generate notifications if appropriate (sellers subscription feed matched buyers subscription info).

Assuming a buyer entered in a request via a web interface to the system to be notified of any “storage-device” that was priced under $100.00, the system upon receiving the buyer's subscription criteria via the internet could store “storage-device” and $100 within its databases. When a seller submitted via the web interface on the internet that he is selling a “SATA-Hard-Drive” for $50, the system would store both pieces of data in its databases. The system could then generate a query that included each of the buyers concepts within the ontology. The system could easily generate a SQL query that includes “storage-device” in addition to AND'ing all the children or sub-types under “storage-device” onto a SQL query along with the price being less than $100 to search for matching buyers requesting the product just offered for sale. For example, assuming we have a database with a table called “seller_products”, a column called “price” holding the product price, a column called “concept” which holds the concept from the ontology entered by the buyer or seller, a simple query generated by the system to find all seller products matching the buyers subscription ontological range criteria could be:

SELECT * from seller_products WHERE concept = “storage-device”
AND concept = “hard-drives” AND concept = “tape” AND
concept = “floppy” AND concept = “removable” AND concept =
“cd-rom” AND concept = “dvd” ... AND price < 50
;

This query would match all children or sub-types of “storage-device”, which is what the buyer wants. The 3 dots or “ . . . ” in the SQL above would be additional AND'ed statements in the SQL query. The program would simply have to enumerate all the children or sub-types of a particular concept or node in the XML to generate a query to find all the matching products for a buyer.

There are a plurality of different ways to implement the present invention and store the subscription and published products and services, generate the matching buyers and seller pairs, and generate the notification messages, as anyone skilled in the art will know. The above example illustrates one very simple method.

Advantages of my invention are:

Although there are websites such as Nextag, Pricegrabber and Google Base, my invention is superior because:
Allows a buyer or seller to categorize a product or service into a distinct predefined concept category type (e.g.: cd-rom drive)
Allows the buyer or seller to receive notifications if a subscription entered for sub-concept matches a published feed for a concept. For example, a buyer could desire to be notified whenever there is a storage device offered for sale between the price of $0 to $50 dollars. When a seller publishes, say a “cd-rom drive” for sale, the system notifies the buyer of a “cd-rom drive” for sale. The system knows that the “cd-rom drive” is a child-concept to the concept category “storage devices” because “cd-rom drive” is a child node to the “storage drive” node within the XML hierarchy (see FIG. 1)
Buyers and sellers can instantly be notified of broad ranges of products or services that they only care about, instead of constantly checking back to websites to see if a product or service is in their target price range.
Is more versatile, in that the buyer or seller can enter attributes for each ontological concept to further narrow any potential matches
Provides a common ontology that buyers and sellers must use to buy and sell products.

The disadvantages of current systems are:
Websites like Nextag and Pricegrabber only allow the user to be notified if the one specific item they are interested in falls below a set price. The user enters a word and the system only notifies the user if there is an exact match for that word for a product being sold.
Websites like Google Base only tag products with a label, and are unable to do any ontological reasoning (such as, is a cd-rom drive a storage drive or vice versa). Furthermore, because users can create any labels they want, ontological reasoning is next to impossible given the plethora or words and misspellings.

Components of the invention and how they interact:

Interaction of components in the real-time ontological subscription and notification system of advertisements for buyers and sellers.

FIG. 2 shows a high level overview of the entire system (though over-simplified). A buyer or seller can (independent of each other) enter in a product or service description, location information (zip code), and price range into the system via a web interface or desktop program.

The Ontological Database System (ODS) will then convert the description into one of the stored concepts (as seen in FIG. 1) used in the ontological hierarchy and save this subscription data into a database. The ODS will then periodically check the system to see if any of the ontological publisher data from sellers matches the ontological subscription data entered by the buyers. It will also check the system everytime a new seller enters new publishable ontological data that is stored in the database system.

If it does find matches, then it will notify the buyer of the potential product or service via the buyer's specified notification medium of choice (e.g.: Email, instant notification, etc). When a new seller of some product or service enters into the system a new product or service with a price and location associated with it, the ODS will run the converted ontological data against all subscriptions entered by buyers into the system, generate a list of matches, and notify the matching buyers of the products or services that match their subscription.

How does the Real-Time Ontological Subscription and Notification System of Advertisements for Buyers and Sellers Achieve its Results (see FIG. 1):

A seller or buyer of a product or service enters a description of a product or service into a web based interface or desktop user interface, which then sends it via internet protocols to the ontological system. The ontological database system receives the description from the buyer or seller looks up the words within the description and returns the ontological concepts that closest resemble the description and returns this data back to the buyer or seller. The seller or buyer can then further refine or change the returned concept description of the product or service. The seller or buyer then enters a price (or price range), quantity, attribute information, and time constraint information that is associated with the product or service which is then sent to the ontological database system. The ontological database system then stores the product or service ontological concept(s), price (or price range), quantity, attribute information, and time constraint information into its database. The ontological database system then runs a query against the database to see if this newly entered data matches any prior data entered into the system. If there are any matches, then it creates a list of users to receive notifications, and notifies each of them according to their notification preferences.

The inventor of the real-time ontological subscription and notification system of advertisements for buyers and sellers has alternative methods of embodying his invention as described below:

The ontological concepts can be stored in a number of data structures. One such example is using an SQL table structure. A parent child relationship could be modeled using two database tables, such that one could be used as a parent table and another as a child table.

The ontological database could use a number of different options to save subscription data (e.g.: XML, flat file system, relational database management system (RDBMS) (e.g.: Oracle), etc)

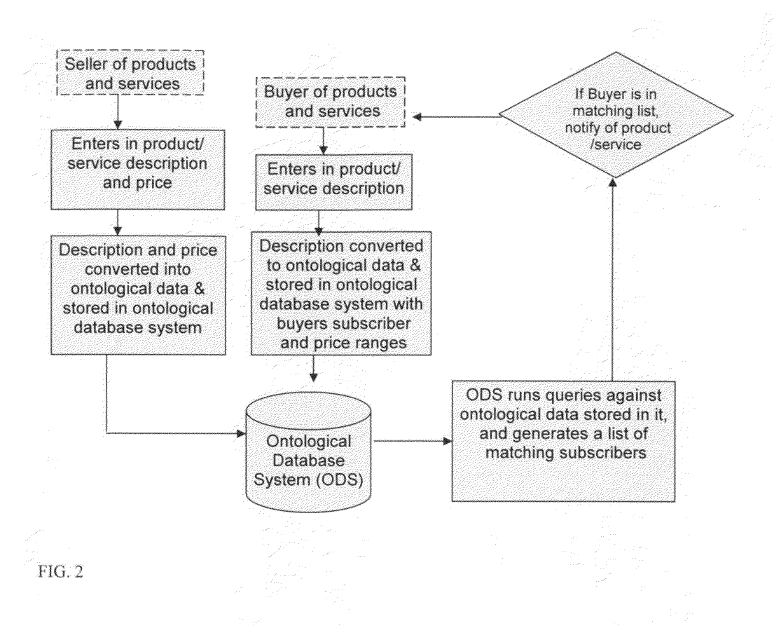

The method and apparatus of the present invention will now be discussed with reference to FIGS. 1, 2, 3, and 4. In a preferred embodiment, the present invention includes central controller 200, seller interface 300, buyer interface 400, and associated databases.

An auto dealership (the seller) wants to inform potential auto consumers (the buyers) of its automobiles (product) that it has in its inventory that it is currently offering with a deep discount (the price). Currently, the only options a seller has is: ads on websites like cars.com, craigslist.org, ads in newspapers and circulars, pop-up ads, ads on television. The potential pool of buyers either have to get lucky and see the advertisements when they are aired or repeatedly go to the websites where the cars are advertised for sale, to see if the car they want is within their price range. What's worse is, the buyers could check back on a website to see if any of the automobiles they are interested in are available randomly over a given time period and could easily miss a week or two when the very product they are interested in is for sale in the buyers target price range.

The present invention comes into play by offering an interface (via a web browser or desktop computer program) to the real-time ontological subscription and notification system. This solves both the buyers and the seller's problems, because:
1) The seller of the products or services does not have to repeatedly enter a list of products or services for sale every week or whenever there is a product he or she wants to sell. When the seller enters in the product or service information (which includes the price constraints, attributes, quantity, etc) into the ontological system, it stays in the ontological system's database until the expiration date and time that the seller has specified has elapsed.
2) The buyer does not have to repeatedly search and check multiple media and website sources to see if the product or service he is interested in is available and at a price he wants. When the buyer enters in the product or service information (which includes the price constraints, attributes, quantity, etc) into the ontological system, it stays in the ontological system's database until the expiration date and time that the buyer has specified has elapsed.
3) The buyer can specify a broad range of concepts that he is interested in that must have a particular attribute associated with it to narrow the subscription results returned by the ontological system
4) The seller can only get customers who are specifically interested in his products or services, and not have to blindly advertise to the masses.

The following XML hierarchy (which is an ontology for automobiles) could be used as an ontological data structure to represent the automobile make and model relationship within the ontological database system (the vertical dots represent where more automobile information would be normally, but we aren't showing for space considerations):

```
<ConceptTree xmlns:features=“http://www.dancclark.com/cars/schema”>
    <automobiles>
        <Toyota>
            <SUV>
```

| | |
|---|---|
| <4Runner | weight=”4660” ></4Runner> |
| <Sequoia | weight=”6704” ></Sequoia> |
| <LandCruiser | weight=”7823” ></LandCruiser> |
| <Highlander | weight=”5540” ></Highlander> |
| <RAV4 | weight=”4983” ></RAV4> |
| <FJCruiser | weight=”5951” ></FJCruiser> |

```
            </SUV>
            <Compact classId=”300” >
                <Corolla id=”301” ></Corolla>
            </Compact>
            <MidSized classId=”400” >
                <Camry id=”401”></Camry>
            </MidSized>
        </Toyota>
        <Honda>
            <SUV>
            .
            .
            .
            </SUV>
            <Compact></Compact>
        </Honda>
        <Ford>
            <SUV></SUV>
        </Ford>
        .
        .
        .
    </automobiles>
</ConceptTree>
```

By expressing the automobile make and model ontological relationship in this very simple way, the present invention, allows the buyer and seller to express a multitude of buying and selling decisions and expressions.

For example, a buyer can now express with a subscription saved to the ontological database system, that he wants to be notified when a Toyota SUV is put on sale for $15,000 or below, that weighs less than 6000 pounds within the next 4 weeks. The ontological database system would look up Toyota to see if it is within its ontological concept database, find the XML node “Toyota” and store the buyer's user id, max price of the vehicle, XML concept node, time constraints, and quantity wanted in its database. A seller of an automobile could come along and then publish that he is selling a Sequoia for $13,000. The ontological database system would look up Sequoia to see if it is within its ontological concept database, find the XML node “Sequoia” (under the parent “Toyota” XML node) and store the sellers user id, price of the vehicle, XML concept node, time constraints, and quantity in its database. Next the ontological database system would run a system wide query against all of its subscriptions. Though the seller never mentioned that he was selling a Toyota or an SUV, the ontological database system can infer this from the ontological relationship inherent within the data structure used (in this case, the XML referenced above). The ontological database system would search all the children nodes if any of all the buyer's subscriptions concepts (in this case, all Toyotas that are SUVs), and other criteria (e.g.: price, location, weight, etc) stored in its database and generate a list of user id's that are matches. It would then notify each user from its list of matches of the product being offered for sale.

In one embodiment of the invention, each parent concept node could be assigned a numerical id so that the ontological database system could easily filter out which children belong to certain parents instantly.

As the ontology (in this case, the XML concept tree seen above) concepts are given more information (such as height, length, gas mileage, passenger seating, horsepower, etc), the buyer and seller can leverage all of this information to create very rich subscriptions and feeds to be notified of from the ontological database system.

The present invention can be used for real estate notifications, airfare, concert tickets, software, and many more products and services.

The objects of my invention are:
to provide an ontology or hierarchical structuring of knowledge/categories about a subset of products and services (e.g.: plasma TV, desktop computer, vacation to Rome) by subcategorizing them according to their essential (or at least relevant and/or cognitive) qualities into rich data structures (e.g.: XML) that a computer system can use. This will be the ontology structures used for product or service subscriptions by buyers and by sellers to publish the product or service that the seller is selling.
to provide a ontological subscription system, that receives subscription queries and data from buyers and sellers about products and services (e.g.: plasma TV, video card, cars, televisions, real estate, vacation to Rome) and stores the ontological subscription info in an database.
to provide a method to transform the subscription query and subscriber information into ontological data that matches up with the systems stored ontology structures used for subscriptions.
to provide a method for the ontological system to run queries against all the ontologically stored subscription info in the ontological database to find category and sub-category matches.
to provide a notification system (e.g.: email, pop-up internet browser window, SMS, instant message, automated phone call) to notify the buyers and sellers subscribing to the system when a matching ontological query or subscription matches the buyers or sellers subscription or query.
to provide a method for the buyer or seller to couple a price or price range with a subscription, feed, query or ontological data such that the buyer or seller is notified if a new subscription feed, query or ontological data is created within the system within the buyer or sellers specified price range.
to provide a subset of hierarchical attributes (e.g.: model, manufacturer, color, height, length, width, etc.) associated with each of the ontological items in the products and services ontological rich data structures
to provide a system such that a buyer or seller can describe a product or service as only one ontological concept (e.g.: cd-rom drive) or a ontological concept and every ontological concept that is a child concept to that ontological concept in the ontology structure (e.g.: “parent concept”=storage devices; “child concepts”=hard-drive, tape-drive, cd-rom, dvd-drive, floppy-drive; Since a hard-drive, tape-drive, cd-rom drive, dvd-drive, and floppy-drive are all part of a subset of devices that storage devices describes)
to provide the buyers and sellers with the option to have a means to create their own concepts or categories for submission to be included in a base ontology structure
to provide a method for buyers or sellers to create conglomerate objects (e.g.: specialized desktop computer) by using/combing the predefined concepts from the ontology structures. For example, using a user interface on a computer, a buyer or seller could group multiple products, such as a computer video card, hard-drive, cd-rom into a group identified by a label.
to provide a method for buyers or sellers to specify optional time constraints (e.g.: expiration date and time) and quantity when entering a description for the product or service they are buying or selling. The present invention will store this criteria in its database and purge the product or service subscription ontology data from the system when it is expired. For example, a seller of a plasma TV could specify that he has three plasma TV's and they all must be sold within 7 days. The system would store the plasma TV under the ontological parent of “televisions” in the systems database and delete the sellers plasma product entry after 7 days have passed.
to provide a web based interface for a user to optionally browse all the products and services being offered by the sellers of said products and services.
to provide a seller of a product or service the option to specify if he or she wants the buyers of the product to be able to buy the product or service, “first come first serve”, auction style, or etc.
to provide a method for the seller or buyer to leave feedback and rating information about buyers and sellers
to provide a method for a buyer or seller to associate an image Uniform Resource Locator (URL) with the product or service they are selling.
to provide a method for a buyer and seller to specify a location of the product or service (e.g.: zip code). The present invention can then narrow the matching subscriptions by proximity.
to provide a method for a buyer or seller to create there own attributes and associate them with a product or service's ontological concept info.

In another preferred embodiment of the present invention, the seller can specify if the buyer is able to buy the product or service immediately from the notification message received by the buyer. For instance, if the buyer receives a notification message for an “ipod nano” via an email message, the email message could contain a Uniform Resource Locators (URL) that allows the user to click the URL and buy the product or service immediately or via one click. The user could click the URL and a window could pop-up prompting the user to login into the website his user credentials, and after the user has logged in, the product or service would automatically be charged to his credit card.

1-40. (canceled)

1. An ontological subscription and publication system with automatic notifications of matching child ontology nodes and parent ontology nodes from subscribing buyers and sellers, comprising:
(a) an ontology comprised of a hierarchy, which can be stored on a computer system in a data structure such as a XML tree, or related database tables, related files on a file system, etc. The ontology hierarchy can be stored in a tree like structure which is composed of various branches and leaves. All of the parts of the hierarchy (e.g.: branches, leaves, etc) can be referred to as individual node(s).
(b) means for storing and retrieving an ontology from a database within a computer system;
(c) means for a buyer or seller to subscribe to automatic notification(s) for any product or service associated with a particular node within the ontology, and for the subscription to be stored in a database within a computer system;
(d) means for a buyer or seller to publish any product or service for sale into the database that is associated with any particular node within the ontology and for the publication to be stored in a database within a computer system;
(e) means for a buyer or seller to specify additional attributes, properties, price constraints, time constraints and other criteria to be attached or used as conditional expressions for their subscription (or publishing) to an ontological node for notifications;
(f) means for the computer system to automatically check the ontology data structure within its database for any matches of buyers and seller nodes.
(g) means for the computer system to automatically email, SMS, instant message, call via phone the buyer or seller if a subscription or publication matches the buyer or sellers notification criteria and falls within the buyer or sellers node range on the ontological tree within the database on the computer system.
(h) An apparatus for facilitating automatic notification between a buyer and at least one of a plurality of sellers, comprising:
a storage device; and a processor connected to the storage device,
the storage device storing a program for controlling the processor; and
the processor operative with the program to receive a collection of subscription criteria which includes, at least one category from the ontology stored on the storage device, a price range or specific price, location, quantity and attributes for the category contained within the ontology;
store and associate the type, sub-type, or category from the ontology with the attributes, price, etc given by the buyer or seller on the storage device;
the processor operative with the program to query the database periodically on the storage device for types, sub-types, or categories for the buyers subscribed products and/or services data that fall within the buyers specified ontological range criteria or match a sellers specified types, sub-types, or categories for the sellers products and/or services that are stored on the database on the storage device;
the processor operative with the program to notify the buyer (or seller) of any matches it has found via the buyer or sellers specified medium of choice; A medium such as email, instant message, automated telephone call, SMS, etc.
(i) The apparatus of claim (h), in which the processor is further operative with the program to: determine if the expiration date or time for the seller's product or service is expired, and to allow the buyer to purchase the product or service immediately via by clicking a button on an interface that displays the notification if the expiration date/time is not passed
(j) means of claim 1, in which the step of inputting into the computer a product or service publication or subscription from a buyer or seller comprises:
inputting into the computer a set of criteria in which objects from the ontology can be included, from each member of a set of sellers/buyers, the set of sellers/buyers comprising at least one seller/buyer; and the computer transmitting the criteria to a networked computer that receives the criteria and stores it.
(k) means of claim 1, in which the seller can decide to allow the first buyer who clicks a buy now button to purchase the product or service.
(l) means for a sub-node in the ontology to match any subscription or publication criteria that specified the sub-nodes parent node. For example, if a buyer wished to be notified of any MP3 music players (parent node) that were for sale under the buyer's specified price, and a seller published an iPod (sub-node) for sale under the buyers price, then the buyer would be notified, since an iPod is a child concept of general concept called “MP3 players”.

2. A method for using a computer to facilitate automatic notifications of products or services to a buyer, from at least one seller's products and/or services data that is mapped within a computer's storage system with an ontology of the products and services, and using a buyer's criteria for products and services that are mapped within a computer's storage system with an ontology, such that the automatic notifications sent to the buyer would be of matching products or services specified by the buyer's subscribed criteria that match the sellers published products and services where both the buyer and sellers product and service descriptions are mapped to an ontology, comprised of:
(a) A system comprised of a storage device, processor, networked devices, buyer(s), seller(s), database, and website where-in the seller enters product or service information on the website that is mapped to the ontology on the networked storage device and said ontological information and other properties are stored in the database, and a buyer who enters product or service information on the website that is mapped to the ontology on the networked storage device and said ontological information and other properties are stored in the database, and automatic periodic polling of the database to determine matches between the terms entered by the buyer and seller, and the automatic notifications of the matching products or services sent to the buyer when all the specified buyer criteria is met.
(b) A method of claim 2, where the buyer can subscribe to notifications via criteria that only specifies properties and not objects within the ontology. For instance, a buyer could specify to be notified of all vacations where any of the objects in the ontology have the property of “beach”. If a seller publishes a vacation to Negril, Jamaica within the buyers specified target price range, the system would know that the “Negril” object which would be under the parent object “Jamaica” has the property “beach”.
